(19) United States
(12) Patent Application Publication
(10) Pub. No.: US 2010/0036671 A1
(43) Pub. Date: Feb. 11, 2010

(54) METHOD AND SYSTEM FOR REAL TIME LEAVE ADMINISTRATION IN COMPLIANCE WITH THE FEDERAL FAMILY AND MEDICAL LEAVE ACT

(76) Inventors: Lee Chu, Plano, TX (US); Aleksander Mrdjenovic, Irving, TX (US); Tina M. Franco, Dallas, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 12/188,314

(22) Filed: Aug. 8, 2008

(51) Int. Cl. G06Q 10/00

(52) U.S. Cl. 705/1

(57) ABSTRACT

A method and system for real time tracking and approving Federal Family Medical Leave Act (FMLA) leave requests is provided. Custom database objects are retrieved and processed, through a secure intranet JavaScript®¹ interface, in real time to provide an employer with employee data associated with the FMLA. The system enables accurate approval or denial of FMLA leave requests for FMLA compliance. The variables for leave expenditures and accruals can be customized to meet the needs of a specific organization. Computational resources are conserved with the use of trigger processing and updating only the desired record. Instantaneous feedback to include an employee's hours worked within a rolling 12 month period, including current usage of vacation, worker's compensation, short-term disability, and sick leave. The system may also provide supervision with real time notification of, for example, new FMLA requests, FMLA status changes, and FMLA leave limits. Additionally, the system provides a user with FMLA eligibility data on a rolling 12-month period. ¹A trademark of Sun Microsystems

### BACKGROUND OF THE INVENTION

The present invention relates generally to accounting and authorization of leave in association with the Federal Family and Medical Leave Act (FMLA).

The FMLA applies, generally, to private companies with 50 or more employees. Public agencies are subject to the FMLA regardless of the number of employees employed. In addition, all schools, private or public, are considered public agencies.

There are eligibility requirements that an employee must meet to be eligible for FMLA leave. Employees who meet eligibility requirements may be approved to take off up to 12 work weeks, 480 hours, in any rolling 12 month period for the birth or adoption of a child, to care for a family member, or if the employee himself has a serious health condition as provided by the FMLA. Approval is, in part, based on criteria in addition to eligibility requirements.

Eligibility requirements include time with the company and number of hours worked. An eligible employee under FMLA criteria is an employee who has been employed with your company for at least one year of cumulative employment and if the employee has worked 1250 hours in a rolling 12 months period. The burden is on the employer to show records that the employee has not worked the required 1,250 hours. There are exceptions to the 1,250 hour requirement. For example, full-time teachers are eligible for FMLA even though they might not work 1,250 hours in a year.

By law, an employer has to respond to a request for FMLA within a specified time or the employee is allowed to take the requested leave as directed by the provisions of the FMLA. More particularly, an employer must give an employee requesting FMLA written notice, within two business days, if they are not eligible for FMLA. If the employer does not respond within two business days, the employee will be eligible to take the leave. The FMLA has additional provisions to which an employer must comply, and in turn must track and record numerous employee data. For example, at the birth or adoption of a child, only a total of 12 weeks combined as between a husband and wife, employed at a same company, are subject to FMLA entitlement.

Compliance with the FMLA requires a significant amount of company time and resources. FMLA requirements are complex and numerous variables frequently need to be taken into account. Variables may include, for example, straight time or overtime, which could count differently towards the 1250 hours needed for FMLA eligibility. Employers have the burden of tracking eligibility and making decisions about FMLA leave within two business days; as such an employer may have to implement a complex program with a multitude of variables to comply with the FMLA.

Before FMLA, an employer could operate under the principle that if an employee did not come in to work as scheduled, then the employee was subject being discharged. Today, employees may be protected, under certain circumstances, under the FMLA and the burden is on the employer to show lack of FMLA leave entitlement. For large and small companies alike, a method and system to automate the leave tracking, FMLA eligibility, and FMLA leave approval would be desirable. Because of the time constraints placed on companies under the FMLA, a timely method and system for FMLA eligibility and FMLA leave approval is also desirable.

Conventional methods of tracking leave may not be adequate to meet the two day response requirement for a request for FMLA leave. An employer may approve an FMLA leave for which an employee was not eligible. The employer may make the approval based on non-updated data or may approve the FMLA leave not knowing whether the employee is eligible but wanting to avoid legal ramifications associated with wrongfully denying FMLA leave.

There are responsibilities on the employee with respect to FMLA leave, which also need to be taken into account in approving or disapproving FMLA leave request. An employer can require 30 days notice for non-urgent needs. An employer may ask the employee to obtain a certification from a physician or other health care professional documenting the need for medical leave. In fact, in the absence of advance notice, an employer may be permitted to delay the start of FMLA for 30 days.

### SUMMARY OF THE INVENTION

The present invention addresses some of the issues presented above, and enables an employer to accurately assess FMLA eligibility in real time and make a well informed approval or denial of FMLA leave requests.

Some aspects of the present invention are described below, while still other attributes of the present invention are not particularly listed as aspects. And further, any one embodiment of the present invention may not include the below provided aspects or may include any combination of summarized aspects.

An aspect of the present invention may provide real time FMLA eligibility status for an employee.

Another aspect of the present invention may provide real time update of an FMLA leave account.

Another aspect of the present invention may provide automatic notification to a supervisor regarding an employee's status for FMLA eligibility.

Another aspect of the present invention may provide accurate FMLA data, which must take into account the previous rolling 12 months, for any given employee in real time.

Another aspect of the present invention may be that the employer controls when the FMLA eligibility and FMLA leave account assessment is performed.

Another aspect of the present invention may be conservation of computational resources, in part by implementation via a trigger versus batch processing.

Another aspect of the present invention may accommodate various types of employees, to include full time or part time and hourly employees.

Another aspect of the present invention may provide for numerous leave code variables, to include, for example, workman's compensation, vacation leave, sick leave, and FMLA leave, and the concurrency or consecutive nature across leave codes.

Yet another aspect of the present invention is that it can be customized to the leave and time policy of the employer and may also vary across employees.

Still another aspect of the present invention is to provide a means to track standing authorizations of FMLA for personal reasons.

Another aspect of the present invention is to provide a visual summary of employee eligibility criteria to a user of an embodiment of the present invention.

Another aspect of the present invention is to provide a means for keeping track of FMLA use within a given department and across different departments, and likewise across shifts, and position types.

Another aspect of the present invention is the real time notification to a supervisor and/or another employer-specified person of an employee's request for FMLA leave.

Another aspect of the present invention is the real time notification to a supervisor and/or another employer-specified person when an employee is approaching the limits of FMLA leave.

Another aspect of the present invention is the real time notification to a supervisor and/or another employer specified person when an employee's request for FMLA leave has been approved.

Another aspect of the present invention is the real time accounting of an employee's rolling 12 month FMLA leave balance and its display to a user of an embodiment of the present invention.

Another aspect of the present invention is the daily accounting of employee leave and FMLA balance for the previous rolling 12 months.

Another object of the present invention is to enable customized access to various databases and results used in accordance with embodiments of the present invention, and to provide secure access as determined by the employer.

Objects of the present invention include enabling employers to accurately approve or disapprove FMLA, to promote effective scheduling of work hours, to reduce unplanned overtime, and to reduce unscheduled time off. Another object of the present invention is to provide an internet based system, for ready integration with desired databases and secure convenient access. Another aspect of the present invention is, through intranet connections and/or internet connections, different departments across a company can see the same employee leave/work summary with respect to FMLA leave requests.

Those skilled in the art will further appreciate the above-noted features and advantages of the invention together with other important aspects thereof upon reading the detailed description that follows in conjunction with the drawings.

### BRIEF DESCRIPTION OF THE FIGURES

For more complete understanding of the features and advantages of the present invention, reference is now made to the detailed description of the invention along with the accompanying figures, wherein:

FIG. 1 shows a block diagram showing the relationship between employee databases, FMLA requests, and the corresponding results in accordance with an embodiment of the present invention;

FIG. 2 shows exemplary leave codes in accordance with an exemplary embodiment of the present invention;

FIG. 3 shows a summary of an employee's FMLA leave status in accordance with an exemplary embodiment of the present invention;

FIG. 4 shows a block diagram illustrating exemplary real time supervisor notifications in accordance with an exemplary embodiment of the present invention shown in FIG. 1;

FIGS. 5A-5B show a flowchart of an exemplary method of an embodiment of the present invention; and

FIG. 6 shows a block diagram of the real time processing and notifications of a request for FMLA leave based on current data, in accordance with an embodiment of the present invention for compliance with the FMLA.

### DETAILED DESCRIPTION OF THE INVENTION

The invention, as defined by the claims, may be better understood by reference to the following detailed description. The description is meant to be read with reference to the figures contained herein. This detailed description relates to examples of the claimed subject matter for illustrative purposes, and is in no way meant to limit the scope of the invention. The specific aspects and embodiments discussed herein are merely illustrative of ways to make and use the invention, and do not limit the scope of the invention.

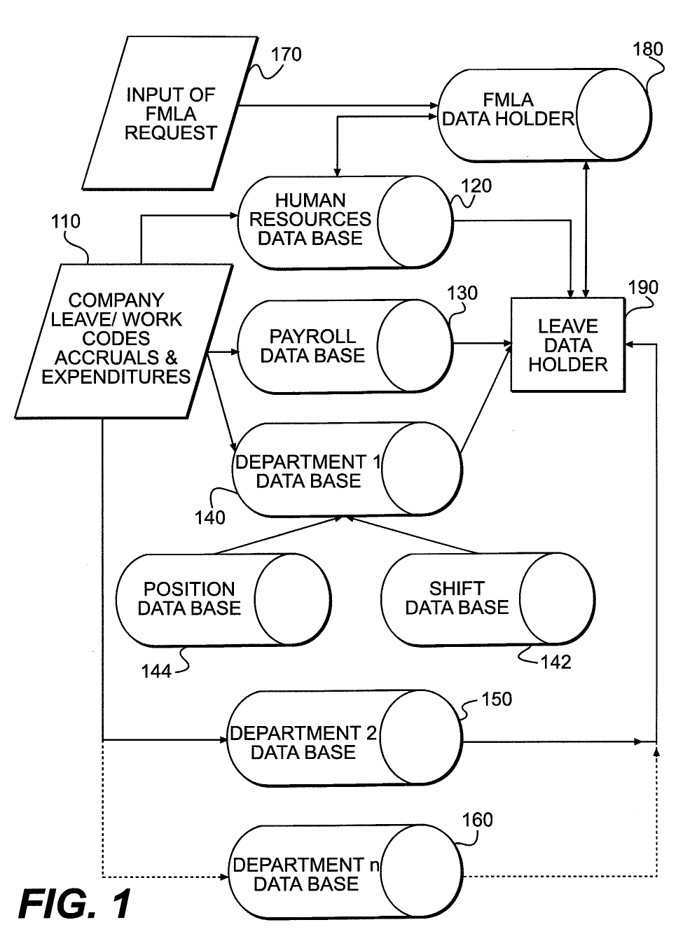

Embodiments of the present invention access multiple databases comprising data that is updated immediately after input, throughout the day. The data is transferred to a holding database for real time access, which may be through internet or intranet connections. Referring to FIG. 1, accruals and expenditures of company leave/work codes 110 input daily into various databases 120, 130, 140, 150, 160. FIG. 1 shows a block diagram showing the relationship between employee databases 120-160, FMLA requests 170, and a FMLA Data Holder 180 and a Leave Data Holder 190 in accordance with an embodiment of the present invention. Employee databases may include department specific databases, 140, 150, 160. Department specific databases may include supplies, logistics, maintenance, and operators. Individual department databases may comprise smaller databases such as employee position databases 144 or shift databases 142. Outputs from respective databases to the FMLA Data Holder 180 or to the Leave Data Holder 190 may be triggered by a FMLA leave request or may be part of a daily batch process to account for the rolling twelve month period associated with the FMLA. Hours worked, leave hours used, and other work/leave code data are entered daily into one or more databases. Via embodiments of the present invention, an internet or intranet based program ties the data from one or more databases into the Leave Data Holder.

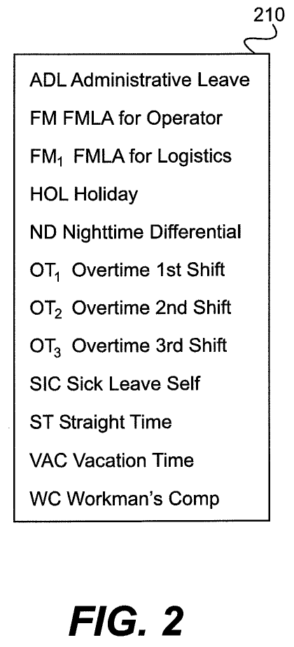

FIG. 2 shows an example of leave/work codes 210 in accordance with an exemplary embodiment of the present invention. Other and/or additional leave/work codes may be defined and used in the methods of the present invention. Some work codes may be weighted with respect to straight time. While this may affect an employee's available leave balances, it may not affect the employee's hours worked. Some codes run concurrently with other codes.

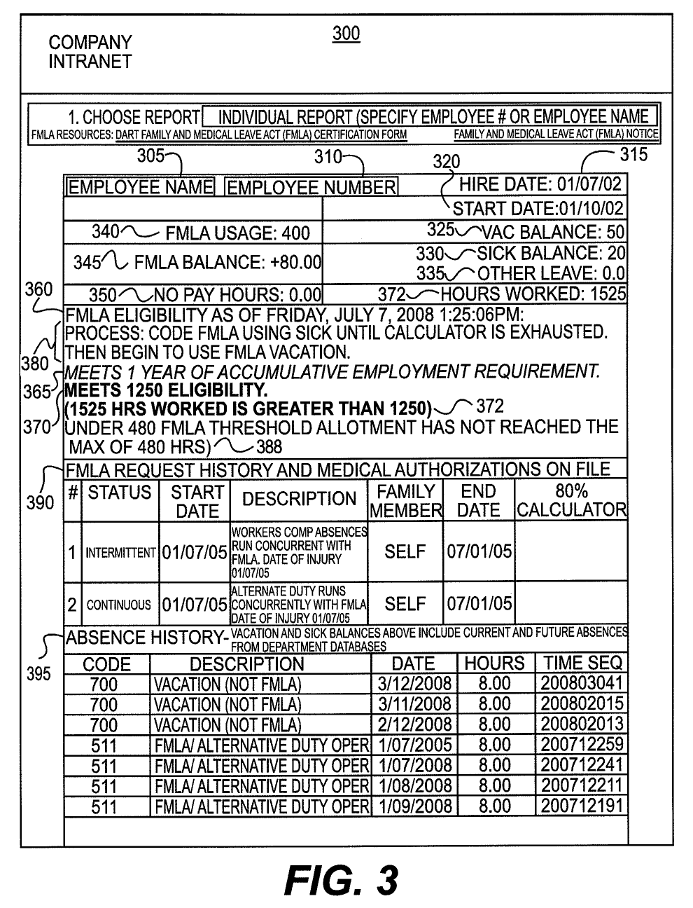

FIG. 3 shows a summary of an employee's FMLA leave status 300 derived from Leave Data Holder 190 data (See FIG. 1) and FMLA Data Holder data 180 (See FIG. 1) in accordance with an exemplary embodiment of the present invention. The summary 300 is presented to any logged-in-user location via an intranet connection using JavaScript. The summary includes a multitude of fields which may include a vacation balance 325, a sick leave balance 330, and a total hours worked in the past rolling 12 months 372. Other fields include hire date 315, FMLA usage 340 in the past rolling 12 months, and FMLA balance 345, number of 480 hours still available for the present rolling 12 month period. FMLA leave summary 300 also includes a determination of FMLA eligibility with respect to the required rolling 12 months employment 365 and with respect to the requirement for 1250 hours worked, 370 within the last rolling 12 months.

In addition to the summary described above, summary 300 may include a history of requested FMLA leave 390 for the subject employee 305 and a history of absences 395.

A method in accordance with the present invention uses a program to retrieve data from objects of customized databases and provides these to an employer, through a secure intranet interface, which may be via, for example JavaScript. An employer is provided with real time employee leave balance information for FMLA accounting. Accrued and expended leave and hours worked, which are updated daily, are provided for the employer's review and are incorporated into a determination of FMLA eligibility. Additional factors are included in the database for outputting an FMLA leave request approval or denial. The online program, in accordance with the present invention, also displays a description of the approved FMLA employee's FMLA medical leave request. Other embodiments of the present invention provide the employer with real time email notification for new FMLA requests, FMLA status changes and/or FMLA data updates. In still other embodiments, updates to worker's compensation, short-term disability, and alternative duty may be included in a summary 300 or included in an email notification. Further, the system provides the FMLA administrator with real time FMLA eligibility data on a rolling 12-month period.

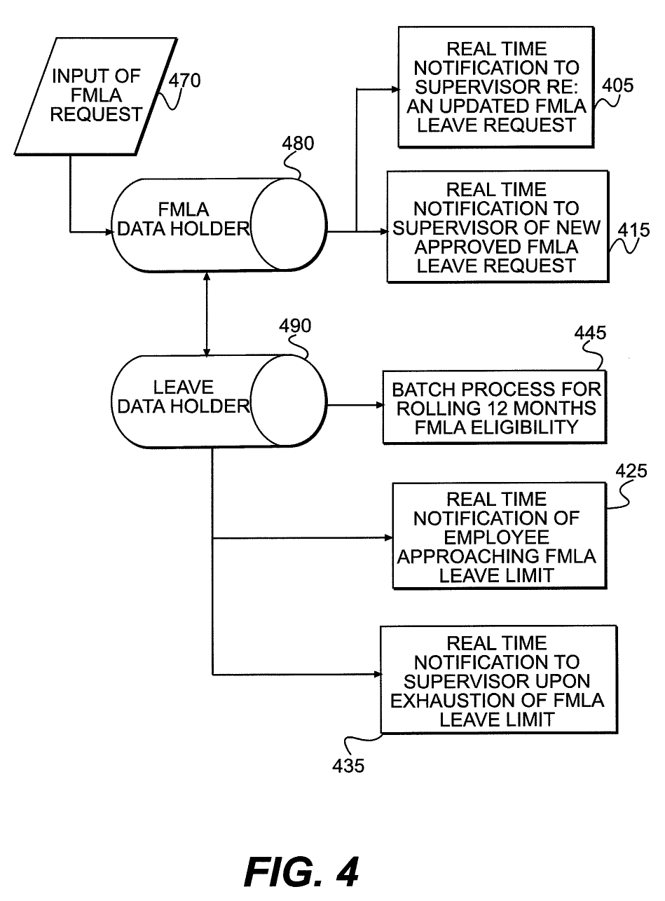

FIG. 4 shows a block diagram illustrating exemplary real time supervisor notifications in accordance with an exemplary embodiment of the present invention shown in FIG. 1. An FMLA request is input into the system for determining FMLA leave 470. This input may be done by the supervisor. Input includes an employee identifier, such as a number or name. The requested time and days are recorded along with the reason for the request. The information is transferred to an FMLA Data Holder 480, which shares the input and other data with the Leave Data Holder 490. If the request for leave is approved, then the new and approved request for FMLA leave may trigger an automatic notification to the respective supervisor 415 or to other individuals as confidentiality permits and a company desires. An updated FMLA leave request may also be input 470, the updated leave request may also include a current doctor's authorization or other medical authorization. Input of an updated FMLA leave request may automatically trigger a notification to a respective supervisor regarding the update 405.

Other calculations and determinations are made in conjunction with the input of the request for FMLA leave. For example, a running total of available FMLA leave is adjusted upon input of a request for leave. In turn, a real time notification of an employee's near exhaustion of FMLA leave allotment may be provided to a respective supervisor 425. If the employee has already exhausted his FMLA leave, then a notification may automatically be sent to the respective supervisors 435. The FMLA operates on a rolling 12 month rolling cycle, and batch processing is performed once every 24 hours on the Leave Data Holder database 445. The daily batch processing can trigger FMLA leave exhaustion or near exhaustion limit notification to a supervisor or other individual. Embodiments of the present invention may include an email notification sent to the employee himself when FMLA leave is exhausted or is nearing exhaustion. Notifications sent to supervisors may be via email.

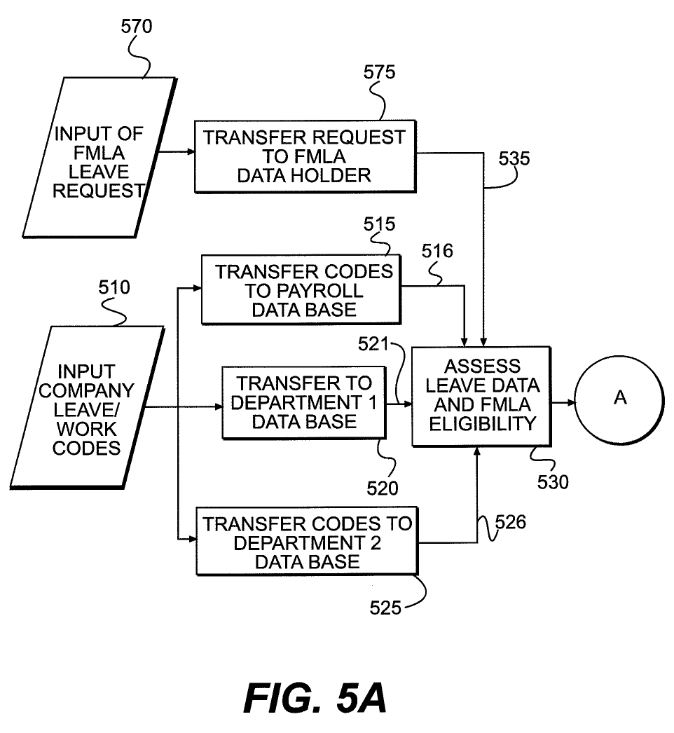

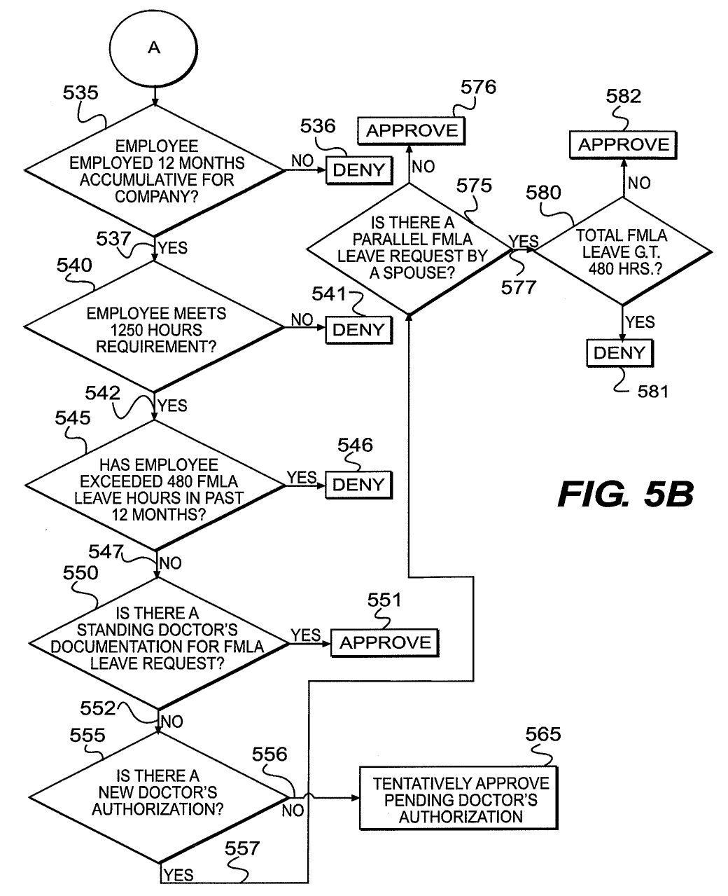

FIG. 5A shows a flowchart of an exemplary method of an embodiment of the present invention. Two inputs are made into the system. Daily inputs are made for each employee regarding leave and work codes for the day 510. Codes are transferred to company databases, for example, the payroll database 515, the Department 1 database 520, and the Department 2 database 525. A request for FMLA leave is input 570 and transferred to the FMLA Data Holder 575. The FMLA Data Holder shares data 535 with the Leave Data Holder. Transfer of codes from payroll database 516 and from the respective employee's department 521 or 526 is triggered by the newly entered request for FMLA leave. The corresponding employee data with leave and work codes are assessed for FMLA compliance 530. Assessment includes determining whether the employee has worked 12 months, accumulative, for the company. The accumulated months with the company is calculated daily with batch processing, in accordance with an embodiment of the present invention. If the employee does not have 12 months of consecutive employment with the company, then the request for FMLA leave will be denied 536 (FIG. 5B) in compliance with the FMLA.

If the employee has met the 12 months of consecutive employment time with the company requirement 537, then a determination is made as to the total number of hours worked in the last rolling 12 months. If the employee has not worked 1250 or more hours in the last rolling 12 months, then the request for FMLA leave will be denied 541. If the employee has worked 1250 or more hours in the last rolling 12 months, then the employee meets another eligibility requirement for FMLA leave 542. Next a determination is made as to the number of FMLA leave hours currently available to the employee 545. If the employee has used 480 hours or more of FMLA leave within the past rolling 12 months 547, then the request for FMLA leave will be denied 546 in compliance with the FMLA. If the employee has not used less than 480 hours of FMLA leave within the past rolling 12 months, then the employee may be eligible to take the FMLA leave as requested. Finally, a medical authorization is also stored in the Leave Data Holder and accessed to determine whether the medical authorization is currently valid or if it has expired 550,552. If a valid Doctor's or medical authorization is stored on the employee's record 551,557, then the FMLA leave may be approved if the FMLA is for the care of the employee himself. In the method embodiment illustrated in FIGS. 5A and 5B, if a Doctor's authorization is present, then the presence of a concurrently employed spouse at the same company will trigger a search of the Leave Data Holder for the leave status and leave requests by the spouse 575.

When the request for leave is not to care for the employee himself, there is a restriction on spouses taking leave to care for another. For example, at the birth or adoption of a child, only a total of 12 weeks combined as between a husband and wife, employed at a same company, are subject to FMLA entitlement. The same conditions apply to caring for an ill parent. If there is no request by a working spouse in the same company for the care of the same individual, the FMLA can be approved 576. If there is a concurrent or serial request, the sum total between both requests must be less than 480 hours 580. If the total is greater than 480 hours, the FMLA leave request can be denied 581, and if not then the FMLA leave request can be approved 582.

If there is no doctor's authorization on file, the employer may deny the FMLA request for leave at their discretion and still be in compliance with the FMLA. Sick leave, if available can be used by the employee for urgent care and may run concurrently with FMLA leave, not shown. Whether or not sick leave is used concurrently with FMLA leave can be customized to meet the policies of the company. In one embodiment, earned sick leave does not run concurrently with FMLA leave and an employee may use earned sick leave without notice to the employer. An intranet based program in accordance with the present invention can be customized to accommodate the company's leave policy.

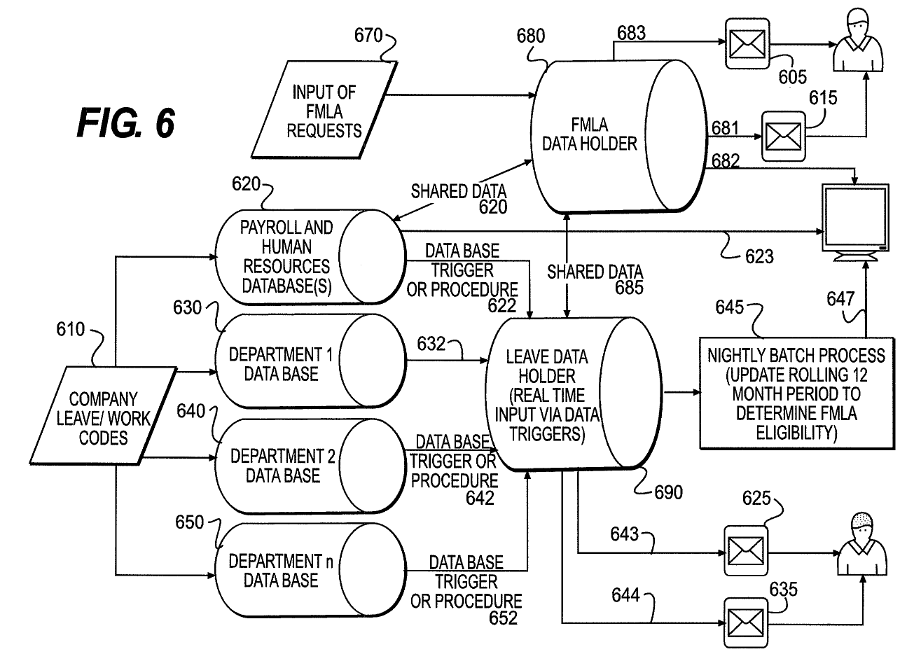

FIG. 6 shows a block diagram of the real time processing and notifications of a request for FMLA leave based on current data, in accordance with an embodiment of the present invention for compliance with the FMLA. Company Leave/Work Codes 610 are entered daily into respective databases, to include Department Databases 630, 640, 650. Leave/work codes are specific to company policy and may include weighting of some factors, such as a nighttime differential as compared to day or straight time. Examples of leave/work codes are provided in FIG. 2. Leave/work codes are also loaded into a Payroll and Human Resources Database 620, which may be two separate databases. The data for the specific employee from these databases is loaded into the Leave Data Holder 622, 632, 642, 652 by trigger upon the input of a request for FMLA leave, providing real time acquisition of up to date leave and work data in the Leave Data Holder 622, 632, 642, 652.

Data is also loaded from the databases to the Leave Data Holder by scheduled procedure 622, 632, 642, 652. In one embodiment, a nightly batch processing 645 occurs to update the Leave Data Holder 690 for a rolling 12 month period. Other scheduled procedures are possible in alternate embodiments of the present invention. However, additional batch processing will utilize additional computational resources and linking bandwidth between the Leave Data Holder 690 and respective databases 620, 630, 640, 650. These batch processes are not employee or record specific to a given request for FMLA leave but may be narrowed by customized design. For example, some departments or shifts may crossover into weekend work hours, while others may not, and only those records affected over the weekend may be included in a batch process run on, for example, a Sunday. Similar considerations can be accounted for with respect to holidays to minimize the batch processing demands while maintaining FMLA approval accuracy and efficiency.

A request for FMLA leave is input 610 into the FMLA Data Holder 680. Data within the FMLA Data Holder 680 is linked to the Payroll and Human Resources Database 620 and Leave Data Holder 690, for real time sharing of data. When an administrator views the FMLA Data Holder 680 and the Leave Data Holder 690 as summarized for the specific individual, approval or denial is indicated based on the method described in FIGS. 5A and 5B. An example of a summary for a specific employee is shown in FIG. 3. Because the Leave Data Holder 690 is updated as needed by batch processing 645 and databases 620, 630, 640, and 650 are accessed in real time by trigger for the specific employee, calculations can be made and instantly displayed, as shown for example in FIG. 3. In a system according to the embodiment shown in FIG. 6 with a summary display in FIG. 3, the approval or denial of FMLA leave is made by an administrator viewing display 300. However, in another embodiment, an employee could enter his own leave request 610, and the approval or denial could be automatically provided to the employee, for example via print out of, for example, summary 300, without the viewing by an administrator.

In FIG. 3, the summary display 300 includes the employee name 305 and may include an employee number 310. A hire date 315 may be included, and the first day of work will be included 320. Balances for vacation 325, sick 330, and other company leave 335 can be displayed. A running total of FMLA leave used during the last rolling 12 months period is provided 340, as well as a calculation of the balance of the 480 hours of FMLA leave for the current rolling 12 months 345 is provided. Additional hours, such as no pay hours 350, or additional leave categories can be presented 335. FMLA eligibility 360 is provided in real time. Whether or not the employee meets the eligibility of one year's accumulative employment 365 is displayed. The display can be, for example, in green when an employee meets the requirement in contrast to a red field if the employee has not yet attained one year of accumulative service. Any ready indication can be used. Similarly, whether or not the employee meets the eligibility of 1250 hours worked within the last rolling 12 months 370 is displayed. As suggested above, the display can be, for example, in green when an employee meets the requirement in contrast to a red field if the employee has not yet worked 1250 hours in the last rolling 12 months. The number of hours worked in the last rolling 12 months is also displayed in a separate field 372.

Additional fields can summarize the real time results of the requested leave, the permitted leave expenditures in view of the employee's current leave status and leave request 380 (See FIG. 3). In accordance with the present invention, the leave policies of the company are incorporated into the processing of FMLA leave approval. For example, the company's policy may be that sick leave or vacation leave, as available, are taken concurrently with FMLA. If sick leave and vacation leave are exhausted, but the employee still needs and is still eligible for FMLA leave, then the employee may be permitted to take leave without pay 380. As an example, an employee may have 80 hours left of FMLA leave and 15 hours of sick leave and a balance of 50 hours of vacation leave. If the employee has requested 60 hours of FMLA leave, then processing this request in accordance with the real time data acquired through the present invention will yield the exhaustion of the 460 hours of the rolling 12 month FMLA allotment, with the concurrent exhaustion of sick leave, and the expenditure of 45 hours of vacation leave. Scheduled batch processing will update each field as needed each day, or upon an additional request for leave by the employee, a triggered process will update the fields. Yet another field, provides an indication of the employee's exhaustion and perhaps negative balance of FMLA leave, as the company permits 388.

Current medical authorizations on file for FMLA leave can be displayed along with a history of FMLA leave requests 390 (FIG. 3). In yet another embodiment, an employee can have a standing medical authorization for FMLA leave, perhaps because of a recurring problem, and FMLA will be automatically approved when the eligibility requirements are met and FMLA allotments have not been exhausted.

Uploading of a new request for FMLA leave into the FMLA Leave Holder 680, triggers the sending of notice 682, 615 to a supervisor. The actual notice embodiment shown in FIG. 6 is an email notification 615. Other methods of notice are possible in accordance with embodiments of the present invention. For example, there may be an electronic leave board within a department which displays leave status for employees with the specific department. Other notice examples include voicemail and instant messaging. In time critical operational departments, more than one mode of notice may be provided and may be provided to multiple persons, such as shift supervisor and department supervisor.

An approval of an FMLA request will also trigger notification 683, 605 to a supervisor and/or additional personnel. Automatic notifications are also sent when an employee reaches eighty percent or greater of the 480 hours of FMLA leave allotted 643, 625. This notification 683 can be triggered during a processing of a new FMLA leave request or during batch processing to account for the 12 month rolling period. If the employee loses FMLA leave eligibility or exhausts the allotted 480 hours, then a notification is sent to one or more supervisors 644, 635. This notification can be automatically triggered upon the processing of a new FMLA leave request or can be sent upon a daily updating of the Leave Data Holder 690. In yet other embodiments, additional or different percentages can trigger supervisor notification as needed or desired.

The rules for FMLA compliance are extensive and require a timely assessment of a variety of work and leave variables. While employees may need to provide 30 days notice for anticipated leave needs to comply with FMLA leave requirements, employers need to be able to provide a timely approval or disapproval. The legal burden of denying FMLA leave requests rests upon the employer. With the present invention, a company's existing databases are tied together in real time to provide all users of the invention with the same timely and updated information. Nightly batch processing can be used to conserve computational and network resources during the busy working hours. Triggered access to data records minimizes the burden on the network during the day, while providing real time accurate FMLA leave approval. In addition to the summary 300 available to users across the network, automatic notification may be provided to supervisors and other designated personnel upon entry of a request for leave, or upon scheduled batch processing.

The present invention is not dependent upon bimonthly payroll data processing to calculate FMLA leave eligibility and provides a real time assessment of FMLA leave eligibility and allotment. The present invention affords the ready integration of databases and secure access to desired data through an internet based program. By providing an accurate and timely method of tracking leave and accurate denial of FMLA leave requests, unscheduled time off may be reduced. This in turn, can reduce unplanned overtime and operating expenses. Employees themselves can be confident that their earned leave entitlements will be fairly distributed. Because the same updated information is available across all system users, perhaps across a company's intranet, optimum scheduling is afforded.

While specific alternatives to steps of the invention have been described herein, additional alternatives not specifically disclosed but known in the art are intended to fall within the scope of the invention. Thus, it is understood that other applications of the present invention will be apparent to those skilled in the art upon reading the described embodiment and after consideration of the appended claims and drawings.

1. A computer-readable medium having stored thereon an instruction set to be executed, the instruction set, when executed by a processor, causes the processor to:
receive leave/work coded data and store in one or more company databases;
receive a request for FMLA leave;
in response to the FMLA leave request, trigger access to the one or more company databases comprising leave/work coded data and transfer the coded data to a leave data holder;
determine in real-time FMLA eligibility and FMLA allotment status using the coded data in the leave data holder;
display FMLA eligibility and FMLA allotment status; and
while displaying FMLA eligibility and FMLA allotment status and in response to subsequently received coded data, transfer the subsequently received coded data in real-time to the leave data holder for updating in real-time eligibility and FMLA allotment status to provide real-time updated FMLA eligibility and FMLA allotment status and display thereof.

2. The computer readable medium of claim 1, wherein the instruction set, when executed by the processor, causes the processor to deny the request for FMLA leave if FMLA eligibility requirements are not met or if FMLA allotment is exhausted.

3. The computer readable medium of claim 2, wherein the instruction set, when executed by the processor, causes the processor to access an employee's leave summary via a secure internet or intranet connection.

4. The computer readable medium of claim 1, wherein the instruction set, when executed by the processor, causes the processor totrigger a notification to a supervisor of the approved FMLA leave request.

5. The computer readable medium of claim 2, wherein the instruction set, when executed by the processor, causes the processor totrigger a notification to a supervisor of a new or updated FMLA leave request.

6. The computer readable medium of claim 1, wherein the instruction set, when executed by the processor, causes the processor to assess the percentage of FMLA leave allotment expended; and
trigger a notification to a supervisor if an FMLA leave allotment is at eighty percent or greater.

7. A computer-readable medium having stored thereon an instruction set to be executed, the instruction set, when executed by a processor, causes the processor to:
schedule a time for daily batch processing of leave work data;
transfer leave work data from company databases to a leave data holder;
process the transferred data by updating for a rolling twelve month period with respect to FMLA eligibility and FMLA allotment of each employee during the scheduled batch processing;
receive a request for FMLA leave for an employee;
transfer the request to an FMLA data holder;
transfer the request to a leave data holder;
in response to receiving the request for FMLA leave, trigger access in real-time to company databases comprising leave/work coded data, and transferring the coded data of the employee to the leave data holder;
calculate FMLA eligibility and FMLA leave allotment for the employee;
display the calculated FMLA eligibility and FMLA allotment of the employee; and
while displaying the calculated FMLA eligibility and FMLA allotment of the employee and in response to subsequently received coded data, transfer in real-time the subsequently received coded data to the leave data holder for recalculating in real-time eligibility and FMLA allotment for the employee to provide real-time display thereof.

8. The computer readable medium of claim 7, wherein the instruction set, when executed by the processor, causes the processor to trigger a notification to a supervisor if an FMLA leave allotment is exhausted.

9. The computer readable medium of claim 7, wherein the instruction set, when executed by the processor, causes the processor to:
retrieve a medical authorization from the leave data holder; and
approve the FMLA request for leave if FMLA eligibility requirements are met, a FMLA allotment is not exhausted, and a valid medical authorization is in the leave data holder.

10. The computer readable medium of claim 7, wherein:
the FMLA leave request is to care for a family member.

11. The computer readable medium of claim 10, wherein the instruction set, when executed by the processor, causes the processor to:
trigger retrieval for a request for FMLA leave for a spouse of the employee;
calculate the employee's FMLA allotment with respect to an approved spouse request for FMLA leave and approving the FMLA request for leave if FMLA eligibility requirements are met, a FMLA allotment is not exhausted, and a valid medical authorization is in the leave data holder

12. The computer readable medium of claim 7, wherein the instruction set, when executed by the processor, causes the processor to:
receive a request for FMLA leave within 30 days of a requested start date; and
tentatively approve the FMLA request for leave contingent upon acquisition of a valid medical authorization if FMLA eligibility requirements are met and a FMLA allotment is not exhausted.

13-20. (canceled)
